(19) United States
(12) Patent Application Publication
(10) Pub. No.: US 2025/0142001 A1
(43) Pub. Date: May 1, 2025

(54) IMAGE READING CONTROL METHOD AND IMAGE READING DEVICE

(71) Applicant: KYOCERA Document Solutions Inc., Osaka (JP)

(72) Inventor: Hayato Hirayama, Osaka (JP)

(21) Appl. No.: 18/932,256

(22) Filed: Oct. 30, 2024

(30) Foreign Application Priority Data
Oct. 31, 2023 (JP) 2023-186069

(51) Int. Cl. H04N 1/00; H04N 1/028; H04N 1/031; H04N 1/401

(52) U.S. Cl. CPC H04N 1/00082; H04N 1/00013; H04N 1/00031; H04N 1/00063; H04N 1/02815; H04N 1/031; H04N 1/401

(57) ABSTRACT

A control device causes a light emitting portion of an image sensor module to emit light, and executes test reading control for acquiring line image data a plurality of times when an output light amount of the light emitting portion differs. The control device, from the line image data, identifies two divided image data corresponding to two adjacent target sensor chips. The control device derives two representative comparison values that are representative values of the two divided image data, respectively. The control device sets the output light amount in the next test reading control in accordance with a magnitude relationship between a difference between the two representative comparison values and a reference value, and a number of times the test reading control has been executed. The control device sets the output light amount in the test reading control when a predetermined determination condition is satisfied as a reference light amount.

### INCORPORATION BY REFERENCE

This application is based upon and claims the benefit of priority from the corresponding Japanese Patent Application No. 2023-186069 filed on Oct. 31, 2023, the entire contents of which are incorporated herein by reference.

### BACKGROUND

The present disclosure relates to an image reading control method and an image reading device in which an image of a document is read by an image sensor module having a plurality of image sensor chips.

The image reading device includes an image sensor module including a plurality of photoelectric conversion elements, and generates line image data representing the amount of light detected by the plurality of photoelectric conversion elements.

When the image sensor module is a contact image sensor (CIS), the image sensor module further includes a light emitting portion configured to irradiate light onto a target area along a main direction. The plurality of photoelectric conversion elements detect the amount of light reflected by the target area.

The image reading device performs shading correction on the line image data in order to reduce unevenness in illumination by the light emitting portion. The correction data used for the shading correction is set based on the line image data obtained under a condition in which a white reference surface faces the image sensor module.

### SOLUTION TO PROBLEM

The image reading control method according to one aspect of the present disclosure, is a method for controlling an image reading device. The image reading device includes an image sensor module and a reference member. The image sensor module includes a light emitting portion configured to irradiate light onto a target area along a main direction, and a plurality of image sensor chips, each including a plurality of photoelectric conversion elements and arranged along the main direction. The reference member has a reference surface facing the image sensor module. The image reading device generates line image data representing an amount of light detected by the plurality of photoelectric conversion elements of each of the plurality of image sensor chips. The image reading control method includes a control device causing the light emitting portion to emit light when the image sensor module faces the reference surface, and executing test reading control for acquiring the line image data a plurality of times under conditions in which an output light amount from the light emitting portion differs. Furthermore, the image reading control method includes the control device identifying, from the line image data obtained for each test reading control, two divided image data corresponding to two adjacent target sensor chips among the plurality of image sensor chips. Moreover, the image reading control method includes the control device deriving two representative comparison values that are representative values of a part or a whole of each of the two divided image data. In addition, the image reading control method includes the control device setting the output light amount in the next test reading control in accordance with a magnitude relationship between a difference between the two representative comparison values and a reference value, and a number of times the test reading control has been executed, every time the test reading control is executed. Further, the image reading control method includes the control device setting the output light amount in the test reading control when a predetermined determination condition is satisfied as a reference light amount. Moreover, the image reading control method includes the control device causing the light emitting portion to emit light at the reference light amount when causing the image sensor module to execute an image reading process that reads an image of a document.

An image reading device according to another aspect of the present disclosure includes the image sensor module, the reference member, and the control device that achieves the image reading control method.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image reading device according to an embodiment.

FIG. 2 is a configuration diagram of an image sensor module in an image reading device according to an embodiment.

FIG. 3 is a block diagram showing a configuration of a user interface and a control device in an image reading device according to an embodiment.

FIG. 4 is a block diagram showing a configuration of a processing module in a CPU of an image reading device according to an embodiment.

FIG. 5 is a plan view of an image sensor module in an image reading device according to an embodiment.

FIG. 6 is a flowchart showing a first example of a procedure of a light amount adjustment process in an image reading device according to an embodiment.

FIG. 7 is a flowchart showing a second example of a procedure of a light amount adjustment process in an image reading device according to an embodiment.

FIG. 8 is a diagram showing an example of a photoelectric conversion characteristic of a line sensor in a CIS module.

FIG. 9 shows an example of a distribution of output voltage levels of two adjacent image sensor chips in a line sensor of a CIS module.

### DETAILED DESCRIPTION

Hereinafter, embodiments according to the present disclosure will be described with reference to the drawings. Note that the following embodiments are examples of a technique according to the present disclosure and do not limit the technical scope according to the present disclosure.

An image reading device 1 according to an embodiment executes an image reading process for reading an image of a document 9. For example, the image reading device 1 may be configured as a part of an image processing apparatus such as a copying machine, a facsimile apparatus, or a multifunction peripheral.

In the following description, the image read from the document 9 by the image reading process of the image reading device 1 is referred to as a read image.

### Configuration of Image Reading Device 1

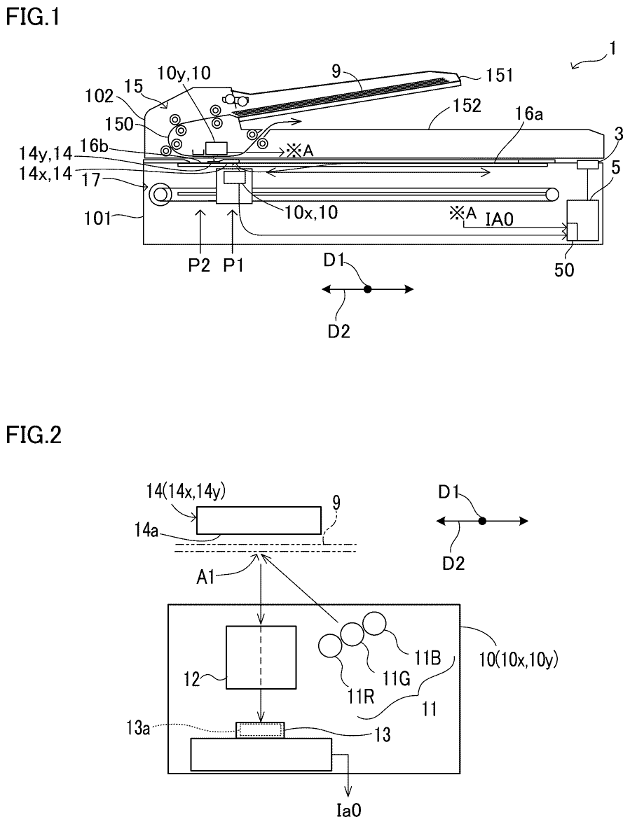

In the present embodiment, the image reading device 1 includes a main body 101, a document cover 102, a document conveying device 15, a first CIS module (Contact Image Sensor Module) 10x, a second CIS module 10y, a platen glass portion 16a, a contact glass portion 16b, and a module moving device 17 (see FIG. 1).

Furthermore, the image reading device 1 also includes a user interface device 3 and a control device 5.

In FIG. 1, a direction into the drawing is a main scanning direction D1, and a direction to the left and right is a sub-scanning direction D2. The sub-scanning direction D2 is a direction crossing the main scanning direction D1. In the present embodiment, the sub-scanning direction D2 is a direction perpendicular to the main scanning direction D1.

The main body 101 is a housing that houses the first CIS module 10x, the module moving device 17, and the control device 5. The platen glass portion 16a and the contact glass portion 16b form part of an upper surface of the main body 101.

The platen glass portion 16a and the contact glass portion 16b are in the form of a transparent plate. The platen glass portion 16a is a portion on which the document 9 is placed. The contact glass portion 16b is arranged at a distance from the platen glass portion 16a in the sub-scanning direction D2.

For example, one transparent glass plate includes the platen glass portion 16a and the contact glass portion 16b.

The module moving device 17 moves the first CIS module 10x in the sub-scanning direction D2 within a movable region that extends from below the platen glass portion 16a to below the contact glass portion 16b.

The document cover 102 is supported so as to be rotatable between a closed position and an open position. In the closed position, the document cover 102 covers upper surfaces of the platen glass portion 16a and the contact glass portion 16b. In the open position, the document cover 102 exposes the upper surfaces of the platen glass portion 16a and the contact glass portion 16b.

The document conveying device 15 is provided in the document cover 102. The document conveying device 15 feeds out the document 9 on a supply tray 151 to a conveying path 150. Furthermore, the document conveying device 15 conveys the document 9 along the conveying path 150 that passes over the upper surface of the contact glass portion 16b. Moreover, the document conveying device 15 conveys the document 9 from the conveying path 150 onto a discharge tray 152.

Each of the first CIS module 10x and the second CIS module 10y is an image sensor module that reads an image from the document 9. In the following description, each of the first CIS module 10x and the second CIS module 10y will be referred to as a CIS module 10.

The CIS module 10 includes a light emitting portion 11, a lens 12, and a line sensor 13 (see FIG. 2). The light emitting portion 11, the lens 12 and the line sensor 13 are arranged with their respective longitudinal directions aligned along the main scanning direction D1.

The light emitting portion 11 irradiates a target area A1 along the main scanning direction D1 with light. For example, the light emitting portion 11 is an LED array including a plurality of LEDs arranged along the main scanning direction D1. The main scanning direction D1 is the main direction that forms the longitudinal direction of the target area A1.

In addition, the light emitting portion 11 may include a light source and a light-guiding member formed to extend in the main scanning direction D1. The light guide member guides the light emitted from the light source in the main scanning direction D1 and radiates the light to the target area A1.

The light emitting portion 11 includes a red light emitting portion 11R, a green light emitting portion 11G, and a blue light emitting portion 11B. For example, the red light emitting portion 11R, the green light emitting portion 11G, and the blue light emitting portion 11B emit light simultaneously, causing the light emitting portion 11 to irradiate the target area A1 with white light.

In addition, the red light emitting portion 11R, the green light emitting portion 11G, and the blue light emitting portion 11B emit light in sequence, so that the light emitting portion 11 sequentially irradiates the target area A1 with red light, green light, and blue light.

The lens 12 focuses the reflected light from the target area A1 onto a light receiving portion of the line sensor 13. The line sensor 13 includes a plurality of photoelectric conversion elements 130 arranged in the main scanning direction D1.

The line sensor 13 detects the amount of the reflected light input thereto, and outputs a line image signal IA1 representing a detection result to an Analog Front End (AFE) 50. The line sensor 13 is a CMOS type image sensor.

The CIS module 10 reads the image of the document 9 as a color image. Data of the read image is data of a color image that represents the amount of reflected light of the three colors, red, green, and blue.

The image reading device 1 is capable of performing a stationary document reading process. Furthermore, the image reading device 1 is able to execute a conveyed document reading process with the document cover 102 closed.

In the stationary document reading process, the module moving device 17 moves the first CIS module 10x along the platen glass portion 16a, and the first CIS module 10x reads the image on a lower surface of the document 9 placed on the platen glass portion 16a.

In the conveyed document reading process, the module moving device 17 holds the first CIS module 10x below the contact glass portion 16b, and the document conveying device 15 conveys the document 9 along the conveying path 150. Furthermore, the first CIS module 10x reads an image on a first surface of the document 9 passing over the contact glass portion 16b.

The image reading device 1 further includes a second CIS module 10y provided in the document cover 102. The second CIS module 10y is arranged opposite a specific portion of the conveying path 150.

In the conveyed document reading process, the second CIS module 10y reads an image of a second surface of the document 9 conveyed along the conveying path 150.

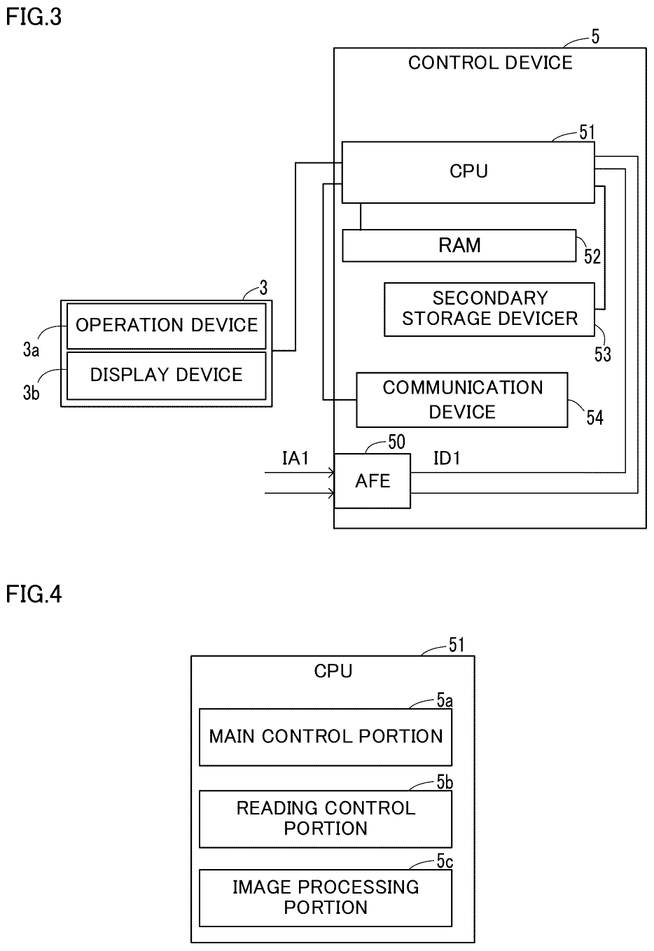

As shown in FIG. 3, the user interface device 3 includes an operation device 3a and a display device 3b. The operation device 3a is a device that receives human operation. For example, the operation device 3a includes operation buttons, a touch panel, and the like.

The display device 3b includes a display panel, such as a liquid crystal panel, capable of displaying images and other information. Note that the human operation includes operation by a human hand, operation by a human voice, operation by human line of sight, and the like.

The control device 5 includes an AFE 50, a central processing unit (CPU) 51, a RAM 52, a secondary storage device 53, and a communication device 54.

The AFE 50 converts the analog line image signal IA1 into digital line image data ID1, and outputs the line image data ID1 to the CPU 51. That is, the image reading device 1 generates line image data ID1 by the AFE 50.

The line image data ID1 includes a plurality of pixel data for one line in the main scanning direction D1. The plurality of pixel data are data representing the amounts of light detected by the plurality of photoelectric conversion elements 130 in the CIS module 10.

Line image data ID1 for a plurality of lines corresponding to one page of the document 9 is data of the read image corresponding to one page of the document 9.

The secondary storage device 53 is a computer-readable non-volatile storage device. The secondary storage device 53 is capable of storing computer programs and various types of data. For example, one or both of a solid state drive (SSD) and a hard disk drive are employed as the secondary storage device 53.

The CPU 51 is a processor that executes various types of data processing and control by executing computer programs stored in the secondary storage device 53. Note that it is also possible that another processor such as a DSP may execute the data processing and control instead of the CPU 51.

The RAM 52 is a computer-readable volatile storage device. The RAM 52 is accessed by the CPU 51. The RAM 52 temporarily stores data to be processed by the CPU 51 and data generated by the CPU 51.

The CPU 51 can communicate with a host device (not shown), which is an external device, via a network such as a local area network (LAN). The host device is a computer capable of communicating with the image reading device 1.

The communication device 54 is a communication interface device that communicates with the host device via the network. The CPU 51 performs all data transmission and reception between the host device and the CPU 51 via the communication device 54.

For example, the CPU 51 transmits data of the read image obtained by the image reading process to the host device via the communication device 54.

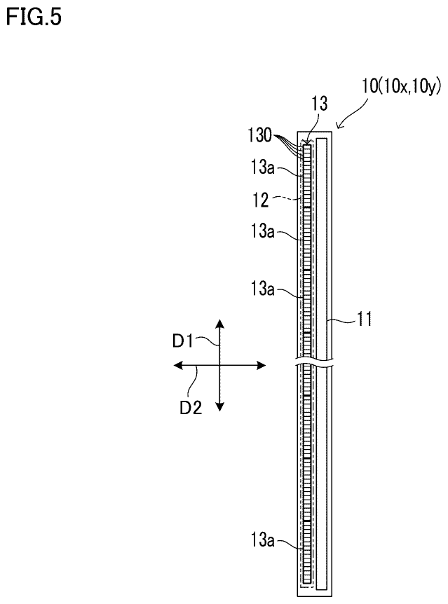

The CPU 51 includes a plurality of processing modules that are achieved by executing the computer programs. The plurality of processing modules include a main control portion 5a, a reading control portion 5b, and an image processing portion 5c (see FIG. 4).

The main control portion 5a monitors operations on the operation device 3a and data reception by the communication device 54. Furthermore, when the main control portion 5a detects an operation or data reception, the main control portion 5a controls the start of processing according to the detected content.

The reading control portion 5b controls the module moving device 17 and the first CIS module 10x to cause the image reading device 1 to execute the stationary document reading process. Furthermore, the reading control portion 5b, by controlling the document conveying device 15, the first CIS module 10x, and the second CIS module 10y, causes the image reading device 1 to execute the conveyed document reading process.

The image processing portion 5c executes various types of processes on the line image data ID1 obtained by the stationary document reading process or the conveyed document reading process. The image processing portion 5c is an example of a data processing portion that processes the line image data ID1.

The reading control portion 5b, by controlling the module moving device 17, causes the first CIS module 10x to move to a predetermined home position P1.

The reading control portion 5b causes the module moving device 17 to execute a moving process in the stationary document reading process. The moving process is a process of moving the first CIS module 10x from the home position P1 to an end position of a reading range, and then returning the first CIS module 10x to the home position P1.

The reading control portion 5b causes the first CIS module 10x to start the image reading process while the module moving device 17 is executing the moving process.

In the conveyed document reading process, the reading control portion 5b moves the first CIS module 10x from the home position P1 to the reading position P2, and stops the first CIS module 10x at the reading position P2. The reading position P2 is a position below the contact glass portion 16b.

The image reading device 1 further includes a first reference member 14x and a second reference member 14y each arranged along the main scanning direction D1 (see FIG. 1).

The first reference member 14x is arranged at a position facing the first CIS module 10x when the first CIS module 10x is located at the home position P1. The second reference member 14y is arranged at a position facing the second CIS module 10y across the conveying path 150.

In the following description, each of the first reference member 14x and the second reference member 14y will be referred to as the reference member 14. The reference member 14 has a reference surface 14a facing the CIS module 10 (see FIG. 2).

The reference surface 14a is a surface of uniform color with high diffuse reflectance. For example, the reference surface 14a is a white surface. In addition, the reference surface 14a may be a light yellow surface. The reference surface 14a is a surface that is read by the CIS module 10 when shading correction is performed.

The image processing portion 5c sets first correction data using the line image data ID1 obtained by the first CIS module 10x when the first CIS module 10x is at the home position P1. The first correction data is data of correction coefficients used for shading correction of the line image data ID1 obtained by the first CIS module 10x.

Furthermore, the image processing portion 5c sets second correction data using the line image data ID1 obtained by the second CIS module 10y when the document 9 is not being conveyed. The second correction data is data of correction coefficients used for shading correction of the line image data ID1 obtained by the second CIS module 10y.

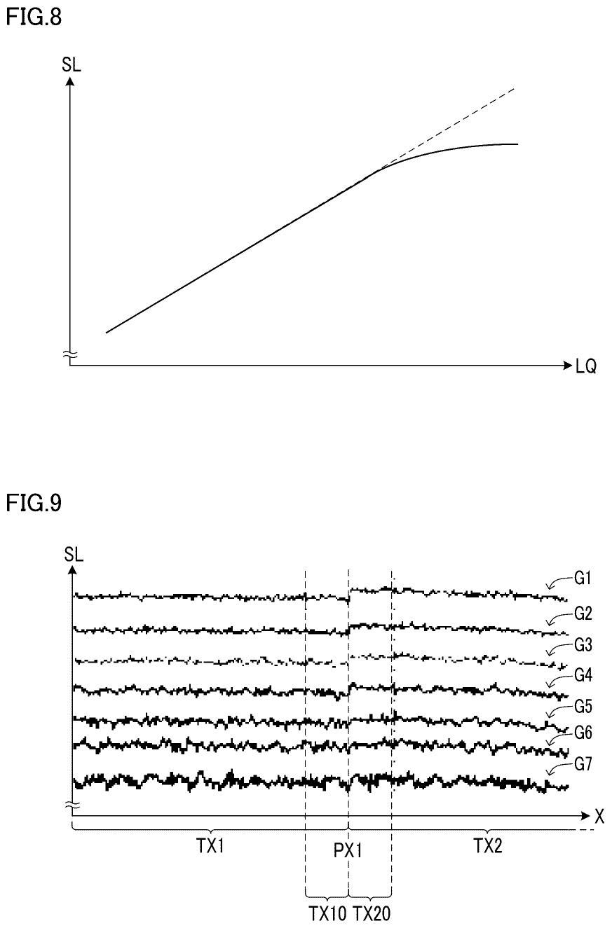

The shading correction is a process that is performed on the assumption that photoelectric conversion characteristic of the CIS module 10 is linear. The photoelectric conversion characteristic is a relationship between the amount of input accumulated light LQ and the output voltage level SL (see FIG. 8). The input accumulated light amount LQ is the amount of light accumulated in each photoelectric conversion element 130 each time one line of an image is read.

In the present embodiment, the line sensor 13 of the CIS module 10 includes a plurality of image sensor chips 13a arranged along the main scanning direction D1 (see FIG. 5). Each of the image sensor chips 13a includes a plurality of photoelectric conversion elements 130 (see FIG. 5).

FIG. 8 shows an example of the photoelectric conversion characteristic of the line sensor 13 in the CIS module 10. In the graph shown in FIG. 8, the horizontal axis represents the input accumulated light amount LQ, and the vertical axis represents the output voltage level SL of the photoelectric conversion element 130 of the CIS module 10.

As shown in FIG. 8, in a case in which the input accumulated light amount LQ is below a predetermined level, the photoelectric conversion characteristic of each image sensor chip 13a has linearity. However, in a case in which the input accumulated light amount LQ is large, each image sensor chip 13a has a nonlinear photoelectric conversion characteristic.

In the CIS module 10, the output light amount from the light emitting portion 11 affects the input accumulated light amount LQ. Therefore, when the output light amount from the light emitting portion 11 is too large, linearity of the photoelectric conversion characteristic of each image sensor chip 13a is lost.

When the CIS module 10 is used in a state in which the output light amount from the light emitting portion 11 is too large, a large local voltage level difference occurs in the output voltage of the CIS module 10.

FIG. 9 shows an example of distribution of the output voltage levels SL of two adjacent image sensor chips 13a in the line sensor 13 of the CIS module 10. In FIG. 9, the horizontal axis X represents the position in the main scanning direction D1.

In FIG. 9, a first coordinate area TX1 and a second coordinate area TX2 are areas corresponding to two adjacent image sensor chips 13a. In addition, the boundary position PX1 is a position corresponding to a boundary between two adjacent image sensor chips 13a.

In FIG. 9, a first graph G1 to a seventh graph G7 each show distribution of the output voltage level SL under conditions in which the output light amount from the light emitting portion 11 is different.

The first graph G1 is a graph in a case in which the output light amount from the light emitting portion 11 is 100%. A second graph G2 is a graph in a case in which the output light amount from the light emitting portion 11 is 90%. A third graph G3 is a graph in a case in which the output light amount from the light emitting portion 11 is 80%. A fourth graph G4 is a graph in a case in which the output light amount from the light emitting portion 11 is 70%. A fifth graph G5 is a graph in a case in which the output light amount from the light emitting portion 11 is 60%. A sixth graph G6 is a graph in a case in which the output light amount from the light emitting portion 11 is 50%. A seventh graph G7 is a graph in a case in which the output light amount from the light emitting portion 11 is 40%.

As shown in FIG. 9, the voltage level difference occurs at a boundary position PX1 that corresponds to the boundary between two adjacent image sensor chips 13a. In addition, the voltage level difference occurs significantly in a case in which the output light amount from the light emitting portion 11 is large (see FIG. 9). On the other hand, in a case in which the output light amount from the light emitting portion 11 is at an appropriate level, the voltage level difference is eliminated.

The voltage level differences appear as vertical streaks in the read image. Therefore, it is required that the output light amount from the light emitting portion 11 in the CIS module 10 be adjusted within a range in which the linearity of the photoelectric conversion characteristic is ensured.

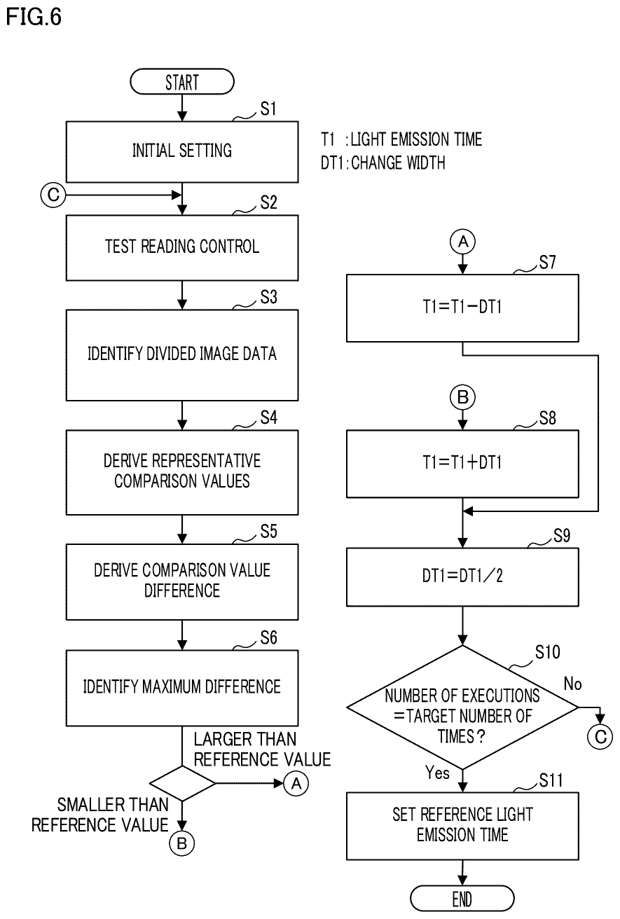

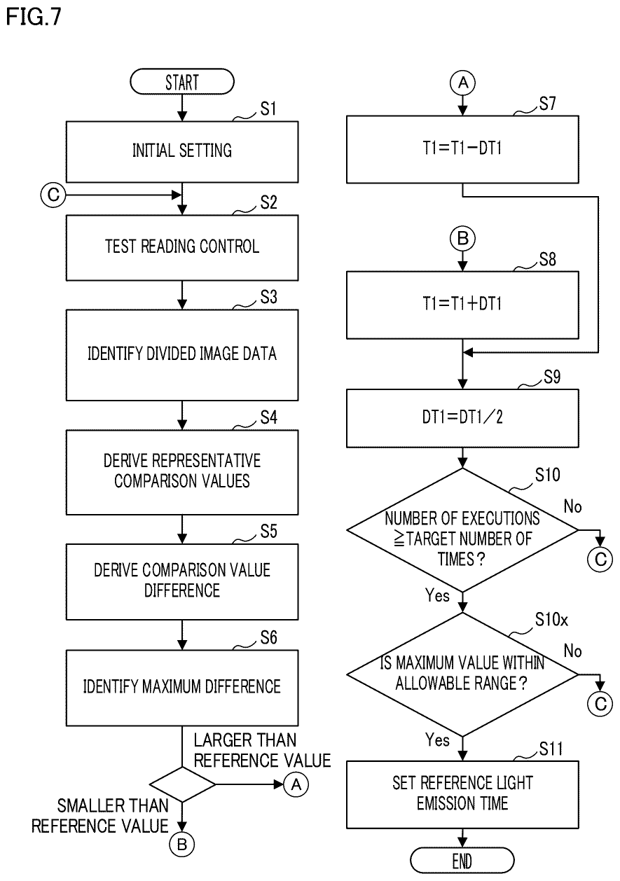

In the present embodiment, the reading control portion 5b and the image processing portion 5c execute a light amount adjustment process, which will be described later (see FIGS. 6 and 7). This allows the output light amount from the light emitting portion 11 to be appropriately adjusted in a case in which an image on the document 9 is read by the CIS module 10 having a plurality of image sensor chips 13a.

For example, when the image reading device 1 is started, the main control portion 5a causes the reading control portion 5b and the image processing portion 5c to execute a light amount adjustment process. In addition, when the main control portion 5a receives a light amount adjustment request via the operation device 3a or the communication device 54, the main control portion 5a may cause the reading control portion 5b and the image processing portion 5c to execute the light amount adjustment process.

The reading control portion 5b and the image processing portion 5c execute the light amount adjustment process for each of the first CIS module 10x and the second CIS module 10y. In addition, the reading control portion 5b and the image processing portion 5c execute the light amount adjustment process under a condition in which the CIS module 10 faces the reference surface 14a of the reference member 14.

That is, the light amount adjustment process for the first CIS module 10x is executed under a condition in which the first CIS module 10x is located at the home position P1. The light amount adjustment process for the second CIS module 10y is executed in a condition in which the document 9 is not being conveyed by the document conveying device 15.

### First Example of Light Amount Adjustment Process

Hereinafter, a first example of the procedure of the light amount adjustment process will be described with reference to the flowchart shown in FIG. 6.

In the following description, S1, S2, . . . represent identification symbols of a plurality of steps in the light amount adjustment process. In the light amount adjustment process, step S1 is executed first.

The light amount adjustment process is an example of a process that achieves an image reading control method that controls the image reading device 1. In addition, the control device 5 including the reading control portion 5b and the image processing portion 5c is an example of a device that achieves the image reading control method.

### Step S1

In step S1, the reading control portion 5b sets a light emission time T1 and a change width DT1 to initial values.

The light emission time T1 is a time during which the light emitting portion 11 emits light in order for the CIS module 10 to read one line of an image. The reading control portion 5b adjusts the output light amount from the light emitting portion 11 by adjusting the light emission time T1.

The change width DT1 is a parameter used for one adjustment of the light emission time T1 in step S8 described later.

After executing the process of step S1, the reading control portion 5b executes the process of step S2.

### Step S2

In step S2, the reading control portion 5b executes test reading control based on the light emission time T1. The test reading control is a process of causing the light emitting portion 11 to emit light for the light emission time T1 and acquiring line image data ID1.

For example, the reading control portion 5b causes the light emitting portion 11 to emit white light in the test reading control. After executing the process of step S2, the reading control portion 5b shifts the process to step S3.

### Step S3

In step S3, the image processing portion 5c identifies two divided image data from the line image data ID1 obtained by the test reading control. The two divided image data are data corresponding to two adjacent target sensor chips among the plurality of image sensor chips 13a.

In the present embodiment, the line sensor 13 of the CIS module 10 has three or more image sensor chips 13a. For example, the line sensor 13 has ten or more image sensor chips 13a.

In step S3, the image processing portion 5c identifies a plurality of sets of the two divided image data corresponding to the plurality of sets of the two target sensor chips. In a case in which the line sensor 13 has twelve image sensor chips 13a, the image processing portion 5c identifies eleven sets of the two divided image data.

After executing the process of step S3, the image processing portion 5c executes the process of step S4.

### Step S4

In step S4, the image processing portion 5c derives two representative comparison values that are representative values of a part or a whole of each of the two divided image data.

In the present embodiment, a plurality of sets of the two representative comparison values are derived for the plurality of sets of the two divided image data.

For example, the image processing portion 5c derives average values of partial data corresponding to specific regions TX10 and TX20 in each of the two divided image data as the two representative comparison values (see FIG. 9). The specific regions TX10, TX20 are regions based on a boundary between the two target sensor chips.

In FIG. 9, a first specific region TX10 is a region within a specific range having a boundary position PX1 as one end within a first coordinate area TX1 corresponding to one of the two target sensor chips. The second specific region TX20 is a region within the specific range having the boundary position PX1 as one end within the second coordinate area TX2 corresponding to the other of the two target sensor chips.

After executing the process of step S4, the image processing portion 5c executes the process of step S5.

### Step S5

In step S5, the image processing portion 5c derives a comparison value difference as a difference between the two representative comparison values.

In the present embodiment, a plurality of the comparison value differences are derived for a plurality of sets of the two representative comparison values. In a case in which eleven sets of the two divided image data are identified, the image processing portion 5c derives the eleven comparison value differences.

After executing the process of step S5, the image processing portion 5c shifts the process to step S6.

### Step S6

In step S6, the reading control portion 5b identifies a maximum difference that is the maximum value among the plurality of comparison value differences derived in step S5. Furthermore, the reading control portion 5b selects the next process depending on whether the maximum difference is larger or smaller than a reference value. The reference value is a predetermined value.

The reading control portion 5b executes the process of step S7 in a case in which the maximum luminance difference is greater than the reference value. On the other hand, in a case in which the maximum luminance difference is smaller than the reference value, the reading control portion 5b executes the process of step S8.

Note that in a case in which the maximum luminance difference is equal to the reference value, the reading control portion 5b executes one of predetermined processes of step S7 and step S8.

### Step S7

In step S7, the reading control portion 5b updates the light emission time T1 to a time shorter than the current light emission time T1 by the change width DT1.

The process of step S7 is an example of a process of setting the light emission time T1 in the next test reading control to a time shorter than the light emission time T1 in the current test reading control. After executing the process of step S7, the reading control portion 5b executes the process of step S9.

### Step S8

In step S8, the reading control portion 5b updates the light emission time T1 to a time longer than the current light emission time T1 by the change width DT1.

The process of step S8 is an example of a process of setting the light emission time T1 in the next test reading control to a time longer than the light emission time T1 in the current test reading control. After executing the process of step S8, the reading control portion 5b executes the process of step S9.

### Step S9

In step S9, the reading control portion 5b updates the change width DT1 to a value that is half the current change width DT1.

After executing the process of step S9, the reading control portion 5b executes the process of step S10.

### Step S10

In step S10, the reading control portion 5b selects the next process depending on whether or not the number of times the test reading control in step S2 has been executed has reached a target number of times. The target number of times is a predetermined number of times.

In a case in which the number of times the test reading control has been executed has not reached the target number of times, the reading control portion 5b executes the processes from step S2 onwards. Thus, the processes of steps S2 to S10 are repeated until the number of executions of the test reading control reaches the target number of times.

On the other hand, the reading control portion 5b executes the process of step S11 in a case in which the number of times the test reading control has been executed reaches the target number of times.

### Step S11

In step S11, the reading control portion 5b sets the light emission time T1 set in the process of step S7 or step S8 that was last executed as the reference light emission time.

After executing the process of step S11, the reading control portion 5b ends the light amount adjustment process.

When the reading control portion 5b causes the CIS module 10 to execute the image reading process, the reading control portion 5b causes the light emitting portion 11 to emit light for the reference light emission time every time one line of an image is read. That is, each time one line of an image is read, the light emitting portion 11 is caused to emit light with an amount of light corresponding to the reference light emission time.

The process of step S11 of setting the reference light emission time is an example of a process of setting a reference light amount corresponding to the reference light emission time.

As described above, the reading control portion 5b executes the test reading control a number of times under conditions in which the output light amount from the light emitting portion 11 is different (step S2). As described above, the test reading control is a process of causing the light emitting portion 11 to emit light and acquiring line image data ID1 under a condition in which the CIS module 10 faces the reference surface 14a.

The image processing portion 5c identifies the two divided image data from the line image data ID1 obtained for each test reading control (step S3). Furthermore, the image processing portion 5c derives the two representative comparison values for the two divided image data (step S4).

Furthermore, each time the test reading control is executed, the reading control portion 5b sets the output light amount in the next test reading control based on a magnitude relationship between the comparison value difference and the reference value and the number of times the test reading control has been executed (steps S6 to S8). As described above, setting the light emission time T1 is an example of setting the output light amount.

Furthermore, the reading control portion 5b sets the output light amount in the test reading control when a predetermined determination condition is satisfied as the reference light amount (steps S10 and S11). In the present embodiment, the determination condition includes a number condition at which the number of times the test reading control has been executed reaches the target number of times (step S10).

The reading control portion 5b causes the light emitting portion 11 to emit light with the reference light amount when the reading control portion 5b causes the CIS module 10 to execute the image reading process for reading the image of the document 9.

By executing the light amount adjustment process, the reference light amount of the light emitting portion 11 in the CIS module 10 is appropriately set so that the difference in the local output voltage level SL in the portion of the boundary position PX1 becomes small.

Therefore, when the image reading process is executed, the occurrence of vertical streaks in the read image is avoided.

In addition, by setting the target number of times to a sufficiently large number of times, a light amount as large as possible within a range in which the difference in the output voltage level SL in a portion at the boundary position PX1 does not become large is set as the reference light amount of the light emitting portion 11. Thus, a decrease in sensitivity of reading an image by the CIS module 10 is avoided.

### Second Example of Light Amount Adjustment Process

Next, a second example of the procedure of the light amount adjustment process will be described with reference to the flowchart shown in FIG. 7.

In FIG. 7, steps that are the same as the steps shown in FIG. 6 are designated by the same identification symbols.

The second example of the light amount adjustment process is a process in which a process of step S10x is added to the first example of the light amount adjustment process shown in FIG. 6. The differences between the first and second examples will be described below.

### Step S10

In step S10 of the second example, the reading control portion 5b executes the processes from step S2 onwards in a case in which the number of times the test reading control has been executed has not reached the target number of times. Thus, the processes of steps S2 to S10 are repeated until the number of executions of the test reading control reaches the target number of times.

On the other hand, the reading control portion 5b executes the process of step S10x in a case in which the number of executions, which is the number of times the test reading control has been executed, has reached the target number of times. The second example, is an example of a case in which the number of executions is greater than the target number of times, and is also an example of a case in which the number of executions has reached the target number of times.

### Step S10x

In step S10x, the reading control portion 5b selects the next process depending on whether or not the maximum difference identified in step S6 is within a predetermined allowable range.

In a case in which the maximum difference is not within the allowable range, the reading control portion 5b executes the processes from step S2 onward. Thus, the processes of steps S2 to S11 are repeated until the maximum difference falls within the allowable range.

On the other hand, in a case in which the maximum difference is within the allowable range, the reading control portion 5b executes the process of step S11.

### Step S11

In step S11, the reading control portion 5b sets the light emission time T1 set by the process of step S7 or step S8 that was last executed as the reference light emission time.

After executing the process of step S11, the reading control portion 5b ends the light amount adjustment process.

In the second example, the determination condition includes the number of times condition of step S10 and a level difference condition of step S10x. The level difference condition is a condition in which the comparison value difference falls within the allowable range.

Even in a case in which the second example is adopted, the same effects as in a case in which the first example is adopted can be obtained.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image reading control method for controlling an image reading device that generates line image data representing detected light amounts of a plurality of photoelectric conversion elements of each of a plurality of image sensor chips;
the image reading device comprising:
an image sensor module including a light emitting portion configured to irradiate light onto a target area along a main direction and a plurality of image sensor chips, each including a plurality of photoelectric conversion elements and arranged along the main direction; and
a reference member having a reference surface facing the image sensor module;
the image reading control method including:
a control device causing the light emitting portion to emit light when the image sensor module faces the reference surface, and executing test reading control for acquiring the line image data a plurality of times under conditions in which an output light amount from the light emitting portion differs;
the control device identifying, from the line image data obtained for each test reading control, two divided image data corresponding to two adjacent target sensor chips among the plurality of image sensor chips;
the control device deriving two representative comparison values that are representative values of a part or a whole of each of the two divided image data;
the control device setting the output light amount in the next test reading control in accordance with a magnitude relationship between a difference between the two representative comparison values and a reference value, and a number of times the test reading control has been executed, every time the test reading control is executed;
the control device setting the output light amount in the test reading control when a predetermined determination condition is satisfied as a reference light amount; and
the control device causing the light emitting portion to emit light at the reference light amount when causing the image sensor module to execute an image reading process that reads an image of a document.

2. The image reading control method according to claim 1, wherein
in a case in which the image sensor module has three or more image sensor chips,
the control device identifies a plurality of sets of the two divided image data corresponding to a plurality of sets of the two target sensor chips;
the control device derives a plurality of sets of the two representative comparison values for the plurality of sets of the two divided image data; and
the control device compares a maximum value of differences between the plurality of sets of two representative comparison values with the reference value.

3. The image reading control method according to claim 1, wherein
the control device derives average values of a portion of the two divided image data corresponding to a specific region based on a boundary between the two target sensor chips as the two representative comparison values.

4. The image reading control method according to claim 1, wherein
the determination condition includes a number of times condition in which the number of times the test reading control has been executed reaches a target number of times.

5. The image reading control method according to claim 1, wherein
the control device adjusts the output light amount by adjusting a light emission time of the light emitting portion.

6. An image reading device comprising:
an image sensor module including a light emitting portion configured to irradiate light onto a target area along a main direction, and a plurality of image sensor chips that are arranged along the main direction, each of the image sensor chips having a plurality of photoelectric conversion elements;
a reference member having a reference surface facing the image sensor module; and
a control device configured to achieve the image reading control method according to claim 1.
